(19) United States
(12) Patent Application Publication
(10) Pub. No.: US 2008/0175248 A1
(43) Pub. Date: Jul. 24, 2008

(54) Method and Apparatus Regarding Monitoring a Streaming/Conversational-Class Data Session to Detect When a Mobile Data Flow Has been Dropped by a Mobile Network

(76) Inventor: Jagadeesh Dantuluri, Aurora, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/935,167

(22) Filed: Nov. 5, 2007

Related U.S. Application Data
(60) Provisional application No. 60/856,948, filed on Nov. 6, 2006.

(51) Int. Cl. H04L 12/28

(52) U.S. Cl. 370/394

(57) ABSTRACT

These teachings provide for receiving (101) control packets as comprise a part of a packet data flow that itself comprises, at least in part, a mobile data flow. These control packets are then used (102) to monitor a streaming/conversational-class data session to thereby detect when the mobile data flow has been dropped by a corresponding mobile network.

### CROSS-REFERENCE TO RELATED APPLICATION

This application claims the benefit of U.S. Provisional application Ser. No. 60/856,948, filed Nov. 6, 2006, which is incorporated by reference in its entirety herein.

### TECHNICAL FIELD

This invention relates generally to streaming/conversational-class data sessions and more particularly to streaming/conversational-class data sessions in a mobile network.

### BACKGROUND

Communication networks of various kinds are known in the art. This includes mobile networks that serve to provide one-way and two-way communications for mobile end user platforms such as cellular telephones, laptops (and other computers having a small personally portable form factor), personal digital assistants, and so forth. Various such networks can support a variety of communication activities including streaming/conversational-class data sessions. “Streaming” refers to a delivery method for a given medium (such as audio, video, or audio-video) as versus the medium itself, and refers specifically to a delivery of content to an end user to be normally and usually rendered perceivable to the end user, essentially in real time, in conjunction with that delivery. Somewhat similarly, “conversational” refers to real time voice-based traffic such as one would ordinarily associate with telephony-based services.

Unfortunately, such networks are not perfect. As a result, and for any of a myriad of reasons, a given communication session can be dropped. Detecting such drops can comprise an important activity for a network administrator. Such information can be used, for example, to influence diagnostic conclusions, architectural modifications and/or additions, resource reallocations, and so forth. Accordingly, and as one example in this regard, data session drop detectors exist that are able to detect a dropped streaming/conversational-class data session. Such detectors typically comprise specialized network probes. For example, probes exist to interact with 3GPP mobile network interfaces and capture data session control messages from various 3GPP network elements (such as NodeB's, RNC's, SGSN's, GGSN's, and so forth).

Unfortunately, such existing approaches present numerous implementation challenges as networks grow larger and ever more complex. With 3GPP streaming/conversational-class data sessions again as an example, existing probes are interface specific. This, in turn, requires deployment of a variety of probes (such as Gn/Gp interface probes, IuPS probes, Iub probes, and so forth) in order to be assured of developing the desired information regarding dropped streaming/conversational-class data sessions.

As a related problem, 3GPP mobile data network operators must decode various protocols (such as, but not limited to, IP, GTP, OCx, ATM, RANAP, RLC, and so forth) for these above-mentioned varied mobile network interfaces. This, in turn, typically requires a variety of vastly different software decoders to accommodate these different interfaces.

These and various other problems greatly increase engineering complexity, cost, and operational requirements when seeking to employ prior approaches to detect dropped streaming/conversational-class data sessions. These problems only grow worse as networks themselves continue to grow larger and more complex.

### BRIEF DESCRIPTION OF THE DRAWINGS

The above needs are at least partially met through provision of the method and apparatus regarding monitoring a streaming/conversational-class data session to detect when a mobile data flow has been dropped by a mobile network described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a block diagram as configured in accordance with various embodiments of the invention; and

FIG. 5 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, these teachings provide for receiving control packets as comprise a part of a packet data flow that itself comprises, at least in part, a mobile data flow. These control packets are then used to monitor a streaming/conversational-class data session to thereby detect when the mobile data flow has been dropped by a corresponding mobile network. By one approach, this can comprise using the control packets to detect a downgrading of a streaming/conversational-class maximum data rate as corresponds to that streaming/conversational-class data session.

These teachings will also accommodate, if desired, automatically transmitting the detection of a dropped streaming/conversational-class data session and/or identifying a service delivery component that is at least partially responsible for dropping the streaming/conversational-class data session (for example, by obtaining identifying information for the service delivery component from a packet data protocol activation message on, for example, a Gn interface).

So configured and arranged, those skilled in the art will recognize and appreciate that a single type of probe can be employed to detect dropped streaming/conversational-class data sessions at aggregation points in a given network, thereby obviating the previous need to deploy numerous and various types of probes at diverse mobile network interfaces. It will similarly be appreciate that these teachings permit the avoidance to needing to decode a wide variety of protocols as are associated with differing mobile network interfaces. These teachings are highly scalable and will accommodate very large network configurations. It will further be appreciated that these teachings can reduce a field deployment activity from many months to merely a few days.

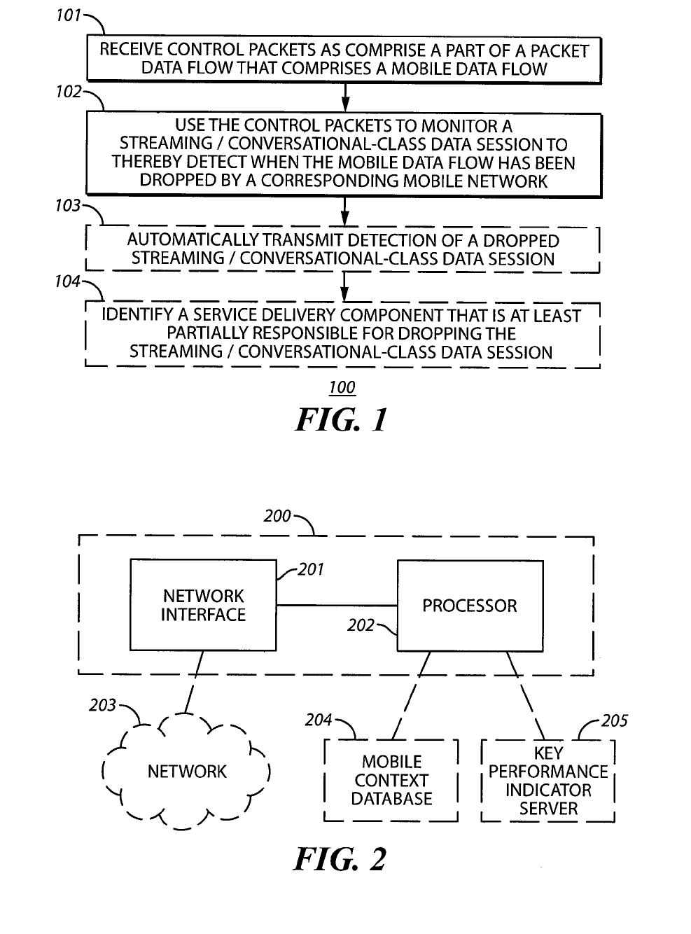

These and other benefits may become clearer upon making a thorough review and study of the following detailed description. Referring now to the drawings, and in particular to FIG. 1, an illustrative process that is compatible with many of these teachings will now be presented.

This process 100 generally provides for receiving 101 control packets as comprise a part of a packet data flow that itself comprises, at least in part, a mobile data flow. By one approach, and as will be shown below in more detail, these control packets can comprise mirrored mobile data packets. For the purposes of illustration and with no intention of suggestion a limitation in this regard, this step of receiving control packets can comprise receiving General Packet Radio Service (GPRS) Tunneling Protocol (GTP) control packets (such as, but not limited to, GPRS Update Packet Data Protocol (PDP) context messages as are known in the art.

This process 100 then provides for using 102 the control packets to monitor a streaming/conversational-class data session to thereby detect when the mobile data flow has been dropped by a corresponding mobile network. For example, and again without intending any specific limitations in this regard, when the control packets include General Packet Radio Service (GPRS) Tunneling Protocol (GTP) control packets, this can comprising monitoring only General Packet Radio Service (GPRS) Tunneling Protocol (GTP-compatible control packets. By one approach, this can comprise decoding a data flow as comprising the streaming/conversational-class data session up to the General Packet Radio Service (GPRS) Tunneling Protocol (GTP) layers as comprise the data flow. This can also comprise, if desired, discarding non-GTP control packets as are decoded when decoding this data flow.

This step of using the control packets to monitor a streaming/conversational-class data session can comprise, for example and not by way of limitation, using the control packets to detect a downgrading of a streaming/conversational-class maximum data rate as corresponds to the streaming/conversational-class data session. As one illustrative example in this regard, this might comprise using the control packets to detect a downgrading of the streaming/conversational-class maximum data rate to zero Kbits/second. Those skilled in the art will recognize and understand that other downgrading thresholds can be selected and utilized if desired. The value of zero, however, will likely prove useful in a variety of application settings.

If desired, this process 100 will further accommodate automatically transmitting 103 the detection of a dropped streaming/conversational-class data session. This can comprise, for example, transmitting such information to a system/network data repository where such information is temporarily or permanently archived. This might also comprise, for example, transmitting such information to a key performance indicator server where network performance is measured, quantified, or the like.

This process 100 will also optionally accommodate, if desired, identifying 104 a service delivery component that is at least partially responsible for dropping the streaming/conversational-class data session. This can comprise, for example, identifying a particular wireless base station, mobile handset, wireless base station controller, SGSN, or other network node that constitutes the point at which the streaming/conversational-class data session was dropped. By way of example and not by way of limitation, this step might comprise obtaining identifying information for the service delivery component from a packet data protocol (PDP) activation message on, for example, a Gn interface.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

As illustrated, a streaming/conversational-class data session drop detector 200 can be generally comprised of a network interface 201 and a processor 202 that operably couples to the network interface 201. The network interface 201 can be configured and arranged to receive control packets as comprise a part of the aforementioned packet data flow as comprises, at least in part, a mobile data flow. Many network interface examples are known in the art and others are likely to be developed in the future. These teachings are generally suitable for use with any such examples. For the purposes of illustration, however, it will be assumed that this network interface 201 comprises an Ethernet interface. (As used herein, “Ethernet” will be understood to refer to wiring and signaling standards as are proscribed in the IEEE 802.3 standard.)

The processor 202, in turn, can comprise a hard-wired dedicated purpose platform or a partially or wholly programmable platform. Such architectural options are well known in the art are require no further elaboration here. For the sake of illustration it will be presumed that the processor 202 comprises a microcontroller or a microprocessor of choice.

The processor 202 is configured and arranged (via, for example, corresponding programming as will be well understood by those skilled in the art) to carry out some or all of the steps, actions, and/or functionality as are described herein as may be desired. This can comprise, for example, using control packets as are received via the network interface 201 to monitor a streaming/conversational-class data session to thereby detect when the mobile data flow has been dropped by a corresponding mobile network. By one approach, this processor 202 is configured and arranged to carry out and/or otherwise facilitate all of the steps described herein.

To effect these purposes, the network interface 201 will typically couple to one or more networks 203 including, but not limited to, the aforementioned mobile network. The processor 202, in turn, can operably couple to a mobile context database 204, a key performance indicator server 205, and so forth as desired. The value of such connections has been alluded to above and will be described in more detail below.

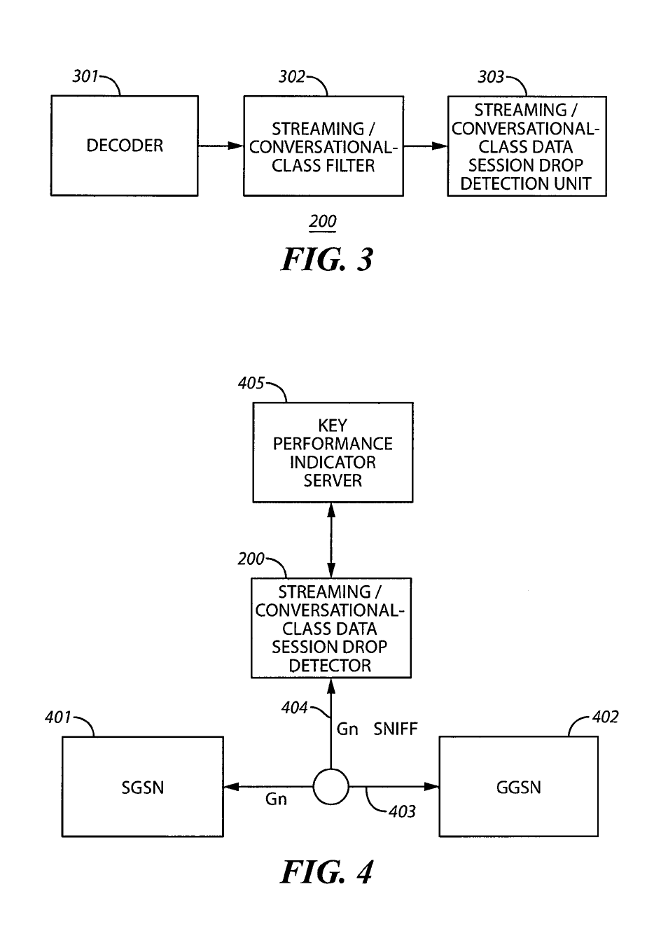

Referring now to FIG. 3, an illustrative logical representation of one approach to realizing a streaming/conversational-class data session drop detector 200 can comprise a decoder 301 that receives the aforementioned mirrored data packets and which decodes the encapsulation protocols for the GTP control packets. The decoded results are then provided to a streaming/conversational-class filter 302.

The streaming/conversational-class filter 302, in turn, determines whether the forwarded GTP control packets comprise streaming/conversational-class packets. Packets that fail this test are discarded and streaming/conversational-class packets are forwarded to a streaming/conversational-class data session drop detection unit 303. The latter serves to assess when a streaming/conversational-class data session drop occurs and to create, for example, a corresponding key performance indicator account regarding that drop. The processed streaming/conversational-class packets can then be discarded as well.

Those skilled in the art will recognize and understand that such an apparatus 200 may be comprised of a plurality of physically distinct elements as is suggested by the illustrations shown in FIGS. 2 and 3. It is also possible, however, to view these illustrations as comprising a logical view, in which case one or more of these elements can be enabled and realized via a shared platform. It will also be understood that such a shared platform may comprise a wholly or at least partially programmable platform as are known in the art.

As noted, these teachings are relevant to a variety of network architectures. FIG. 4 provides one illustrative example in this regard amongst many that are possible. Those skilled in the art will recognize that this example is intended for the purposes of illustration and not by way of limitation.

This illustrative example depicts a streaming/conversational-class data session drop detector 200 deployed as a probe in a 3GPP-based core network. The probe is positioned to process at least Gn traffic 403 as flows between a Serving GPRS Support Node (SGSN) 401 and a Gateway GPRS Support Node (GGSN) 402 as are known in the art. In this embodiment, the probe is receiving mirrored Gn traffic 404. The probe processes this mirrored Gn traffic as described herein and reports detected dropped streaming/conversational-class data sessions to a key performance indicator server 405.

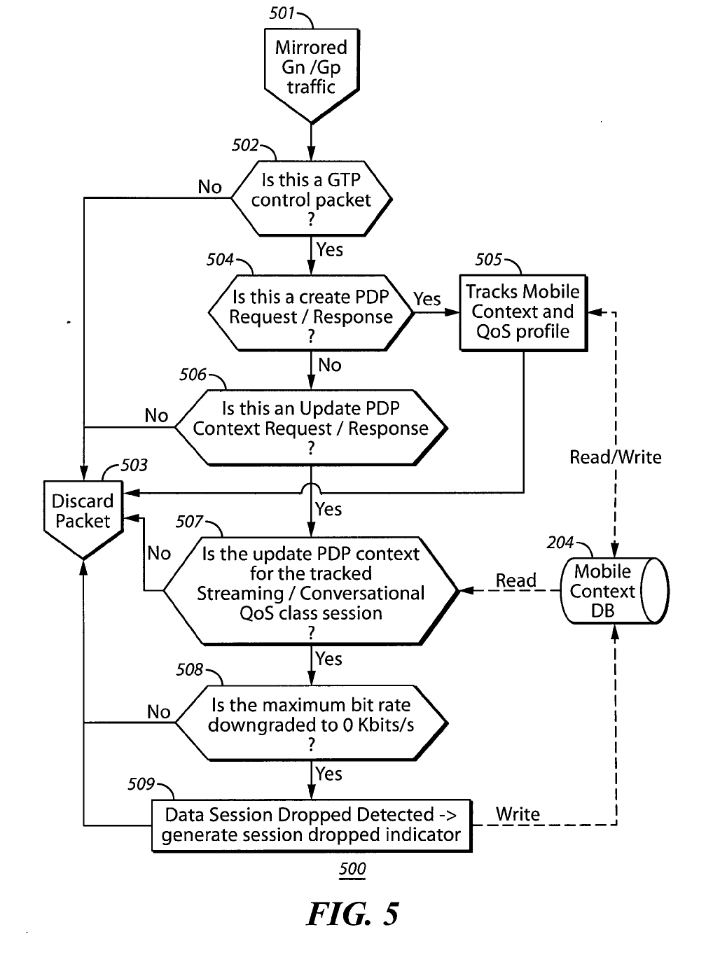

Referring now to FIG. 5, an illustrative exemplary corresponding process 500 will be described. Those skilled in the art will recognize that other possibilities exist in this regard as well with yet others likely to be developed going forward.

This process 500 begins with the step 501 of receiving the aforementioned mirrored Internet Protocol (IP)-based mobile data packets via the aforementioned Ethernet port. This step 501 can comprise saving these packets in one or more data buffers. These buffered mobile-protocol-encapsulated mobile data packets are decoded up to the GTP layers. In step 502 the process 500 determines whether each packet comprises a GTP control packet. Non-GTP control packets are discarded at step 503.

A next step 504 whether each packet comprises a create PDP request/response packet. When true, a next step 505 provides for tracking the mobile context and quality of service profile following which the packets are discarded at step 503. If desired, this tracking information can be stored at the aforementioned mobile context database 204. When the determination at step 504 is false, this process 500 instead proceeds to step 506 where a determination is made regarding whether the packet comprises an update PDP context request/response.

When the determination at step 506 is false, the packet is discarded at step 503. Otherwise, when true, this process 500 makes a determination at step 507 regarding whether the update PDP context request/response packet is for a tracked streaming/conversational-class data session. Tracking information can be obtained, for example, from the mobile context database 204 mentioned earlier. When this determination proves false, the packet is discarded at step 503. When true, however, this process 500 then makes a determination at step 508 regarding whether the update PDP context request/response reflects a downgrading of the corresponding streaming/conversational-class data session maximum data bit rate to (in this illustrative example) 0 Kbits/second.

When this determination at step 508 is false the packet is discarded at step 503. When true, however, this process 500 then provides at step 509 for detecting that the streaming/conversational-class data session has been dropped. The processed packet is then discarded at step 503 and, if desired, a corresponding dropped data session indicator is written to the mobile context database 204.

So configured, those skilled in the art will recognize and appreciate that the described teachings, while being highly effective in use, are nevertheless relatively simple and inexpensive to deploy and implement. A single probe as described, properly coupled at a suitable point of aggregated traffic in a monitored network, can readily and successfully detect dropped streaming/conversational-class data sessions in a mobile data session context in a manner that avoids numerous issues, complications, and obstacles as are ordinarily associated with traditional approaches in this regard.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving control packets as comprise a part of a packet data flow that comprises, at least in part, a mobile data flow;
using the control packets to monitor a streaming/conversational-class data session to thereby detect when the mobile data flow has been dropped by a corresponding mobile network.

2. The method of claim 1 wherein receiving control packets comprises receiving General Packet Radio Service (GPRS) Tunneling Protocol (GTP) Control packets.

3. The method of claim 2 wherein receiving GTP Control packets comprises receiving a GPRS Update Packet Data Protocol (PDP) Context messages.

4. The method of claim 1 wherein using the control packets to monitor a streaming/conversational-class data session comprises using the control packets to detect a downgrading of a streaming/conversational-class maximum data rate as corresponds to the streaming/conversational-class data session.

5. The method of claim 4 wherein using the control packets to detect a downgrading of a streaming/conversational-class maximum data rate comprises using the control packets to detect a downgrading of the streaming/conversational-class maximum data rate to zero Kbits/second.

6. The method of claim 1 wherein receiving control packets as comprise a part of a packet data flow comprises receiving mirrored mobile data packets.

7. The method of claim 1 wherein using the control packets to monitor a streaming/conversational-class data session comprises decoding a data flow as comprises the streaming/conversational-class data session up to General Packet Radio Service (GPRS) Tunneling Protocol (GTP) layers as comprise the data flow.

8. The method of claim 7 wherein using the control packets to monitor a streaming/conversational-class data session further comprises discarding non-GTP control packets as are decoded when decoding the data flow.

9. The method of claim 1 further comprising:
automatically transmitting detection of a dropped streaming/conversational-class data session.

10. The method of claim 1 wherein using the control packets to monitor a streaming/conversational-class data session comprises monitoring only General Packet Radio Service (GPRS) Tunneling Protocol (GTP)-compatible control packets.

11. The method of claim 1 further comprising:
identifying a service delivery component that is at least partially responsible for dropping the streaming/conversational-class data session.

12. The method of claim 11 wherein identifying a service delivery component that is at least partially responsible for dropping the streaming/conversational-class data session comprises obtaining identifying information for the service delivery component from a packet data protocol (PDP) activation message on a Gn interface.

13. An apparatus comprising:
a network interface configured and arranged to receive control packets as comprise a part of a packet data flow that comprises, at least in part, a mobile data flow;
a processor operably coupled to the network interface and being configured and arranged to use the control packets to monitor a streaming/conversational-class data session to thereby detect when the mobile data flow has been dropped by a corresponding mobile network.

14. The apparatus of claim 13 wherein the control packets comprises General Packet Radio Service (GPRS) Tunneling Protocol (GTP) Control packets.

15. The apparatus of claim 14 wherein the GTP Control packets comprises GPRS Update Packet Data Protocol (PDP) Context messages.

16. The apparatus of claim 13 wherein the processor is further configured and arranged to use the control packets to monitor a streaming/conversational-class data session by using the control packets to detect a downgrading of a streaming/conversational-class maximum data rate as corresponds to the streaming/conversational-class data session.

17. The apparatus of claim 16 wherein the processor is further configured and arranged to use the control packets to detect a downgrading of a streaming/conversational-class maximum data rate by using the control packets to detect a downgrading of the streaming/conversational-class maximum data rate to zero Kbits/second.

18. The apparatus of claim 13 wherein the network interface is configured and arranged to receive control packets as comprise a part of a packet data flow by receiving mirrored mobile data packets.

19. The apparatus of claim 13 wherein the processor is further configured and arranged to use the control packets to monitor a streaming/conversational-class data session by decoding a data flow as comprises the streaming/conversational-class data session up to General Packet Radio Service (GPRS) Tunneling Protocol (GTP) layers as comprise the data flow.

20. The apparatus of claim 19 wherein the processor is further configured and arranged to use the control packets to monitor a streaming/conversational-class data session by discarding non-GTP control packets as are decoded when decoding the data flow.

21. The apparatus of claim 13 the processor is further configured and arranged to automatically transmit detection of a dropped streaming/conversational-class data session.

22. The apparatus of claim 13 wherein the processor is further configured and arranged to use the control packets to monitor a streaming/conversational-class data session by monitoring only General Packet Radio Service (GPRS) Tunneling Protocol (GTP)-compatible control packets.

23. The apparatus of claim 13 wherein the processor is further configured and arranged to identify a service delivery component that is at least partially responsible for dropping the streaming/conversational-class data session.

24. The method of claim 23 wherein the processor is further configured and arranged to identify a service delivery component that is at least partially responsible for dropping the streaming/conversational-class data session by obtaining identifying information for the service delivery component from a packet data protocol (PDP) activation message on a Gn interface.
